(19) United States
(12) Patent Application Publication
(10) Pub. No.: US 2010/0125552 A1
(43) Pub. Date: May 20, 2010

(54) METHOD AND SYSTEM FOR UPDATING VIEWER CACHES

(76) Inventors: Barry L. Peterson, Fort Wayne, IN (US); John S. Bryan, Fort Wayne, IN (US); Demron Ignace, Fort Wayne, IN (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/261,458

(22) Filed: Oct. 30, 2008

(51) Int. Cl. G06F 17/30

(52) U.S. Cl. 707/637; 711/118

(57) ABSTRACT

Methods, systems, and articles of manufacture for updating map viewers include associating a first map viewer update cache with a first map viewer, the first map viewer update cache comprising a first map viewer data update, associating a second map viewer update cache with a second map viewer, the second map viewer update cache comprising a second map viewer data update, and sending one of the first and second map viewer data updates from one of the first and second map viewer update caches to the associated one of the first and second map viewers.

### BACKGROUND

As is known in the art, geospatial browsers including Google Earth™, from Google, Inc. of Mountain View, Calif., and World Wind, an open source program from NASA, can be exploited to create interactive, content-rich mapping applications for a variety of purposes. FIG. 11 is an example of Google Earth™ 1100, a virtual globe program capable of displaying three-dimensional objects 1102 superimposed on imagery 1104, such as terrain models obtained from aerial and satellite photography. Organizations may import proprietary data into geospatial viewers to support specific business needs and to offer customized applications to customers.

As is also known in the art, geospatial browsers may consume data in various standardized data formats. For example, Keyhole Markup Language (KML) is a widely used format for expressing geographic annotation and visualization. KML files encode features such as placemarks, images, polygons, three-dimensional data, texture maps, etc. for display in geospatial browsers and static map images. Generally, features are defined using latitude and longitude coordinates in the World Geodetic System of 1984 (WGS84), however, data may also be represented using tilt, pan, rotation, altitude, and heading. Further, camera views may be defined to support map views. A sample of KML is shown below:

<?xml version=“1.0” encoding=“UTF-8”?>
<kml xmlns=“http://www.opengis.net/kml/2.2”>
<Placemark>

<name>New York City</name>
<description>New York City</description>
<Point>

<coordinates>−74.006393,40.714172,0</coordinates>

</Point>

</Placemark>
</kml>

As can be seen from this sample, KML is based on extensible markup language (XML) and includes embedded tags to describe information. The sample KML defines a placemark, which includes a name, description, and location or data point on a map. KML files are often distributed as KMZ files, which are zipped KML files including overlays and icon images referenced within the KML.

### SUMMARY

The inventive techniques, systems, and concepts described herein provide support for efficient updating of information displayed in map viewers. For example, the inventive techniques, systems, and concepts can provide data caches to support updates of map objects displayed in multiple map viewers. The data caches are organized into topics which are defined as applications to support various types of data outputted and viewed on the map viewers. The techniques, systems, and concepts further provide an ability to create custom map objects, customer map object renderers, preferences and configurations associated with the map viewers.

Topics may be coupled to external data sources to track real-world objects, such as aircraft tracked on air traffic control systems. The external data sources provide information updates to the topics, which topics can process to create and save to custom map objects representing the real-world objects, as well as domain-specific features and functions of the application. In one example, a topic can process an update by rendering a map object based on the update and saving the rendered object to data caches. The rendered object may be saved in a specific format, such as Keyhole Markup Language, although any format capable of representing the object may be used.

Topics may include two types of data caches, one for storing all rendered map objects associated with a map viewer, and another for storing only updated information for map objects associated with the map viewer. Map viewers may request (or topics may send) all rendered map objects to initialize or reset a map view, a portion of the rendered map objects viewable at a certain zoom level or map viewing area, or updated information. In one embodiment, links are included for accessing the various caches defined for each map viewer. Thus, the techniques, systems, and concepts described herein can significantly reduce overhead by sending only updated information to map viewers instead of the entire map object collection. This can result in an ability to more rapidly update multiple viewers. Further, map viewers can be customized using custom renderers and styles to save map objects to the caches, and can receive information from caches based upon needs, preferences, and configurations.

In one aspect, the techniques, systems, and concepts described herein are directed towards articles of manufacture for updating map viewers including a storage medium having stored instructions thereon that when executed by a machine result in associating a first map viewer update cache with a first map viewer, the first map viewer update cache comprising a first map viewer data update, associating a second map viewer update cache with a second map viewer, the second map viewer update cache comprising a second map viewer data update, and sending one of the first and second map viewer data updates from one of the first and second map viewer update caches to the associated one of the first and second map viewers.

In another aspect, the techniques, systems, and concepts described herein are directed towards methods for updating map viewers including associating a first map viewer update cache with a first map viewer, the first map viewer update cache comprising a first map viewer data update, associating a second map viewer update cache with a second map viewer, the second map viewer update cache comprising a second map viewer data update, and sending one of the first and second map viewer data updates from one of the first and second map viewer update caches to the associated one of the first and second map viewers.

In another aspect, the techniques, systems, and concepts described herein are directed towards systems including a processor and a memory coupled to the processor, the memory including program instructions for updating map viewers by associating a first map viewer update cache with a first map viewer, the first map viewer update cache comprising a first map viewer data update, associating a second map viewer update cache with a second map viewer, the second map viewer update cache comprising a second map viewer data update, and sending one of the first and second map viewer data updates from one of the first and second map viewer update caches to the associated one of the first and second map viewers.

### BRIEF DESCRIPTION OF THE DRAWINGS

The foregoing features of this invention, as well as the invention itself, may be more fully understood from the following description of the drawings in which:

FIG. 1 is a block diagram of a system for updating map viewers;

FIG. 2 is a block diagram of caches, links, and configurations coupled to respective ones of a plurality of map viewers;

FIG. 3 is a block diagram of entity caches and a propagation of updates from data providers to respective ones of a plurality of map viewers;

FIG. 4A is a block diagram of topics coupled to data providers and associated with respective ones of a plurality of map viewers;

FIG. 4B is a block diagram of map objects and updates associated with respective ones of a plurality of map viewers;

FIG. 5A and 5B are block diagrams of an entity topic and a KML topic, respectively, in accordance with the techniques and systems described herein.

FIG. 6 is a flow diagram of a method for creating and updating a map object in an entity topic;

FIG. 7 is a flow diagram of a method for creating and updating a map object in a KML topic;

FIG. 8 is a flow diagram of a method for handling requests from a KML map viewer;

FIG. 9 is a block diagram showing an exemplary hardware and operating environment of a suitable computer for use with embodiments of the invention;

FIG. 10 is a diagram showing an exemplary client-server environment of a suitable for use with embodiments of the invention; and

FIG. 11 is a pictorial representation of a conventional geospatial viewer of the type for use with embodiments of the invention.

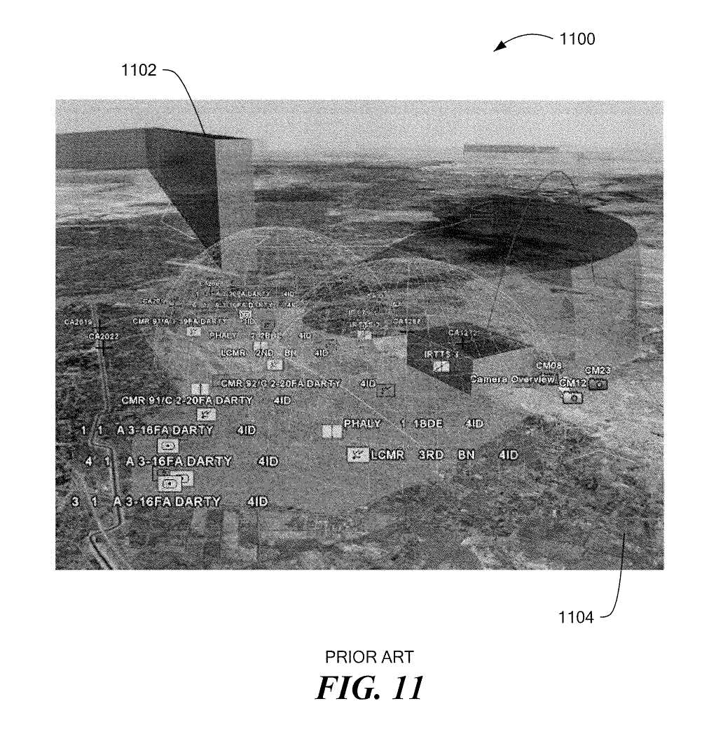

### DETAILED DESCRIPTION

Although many of the example embodiments of the techniques and systems described throughout the present application refer to military applications, such references are made only for clarity in the description and should not be construed as limiting. The techniques and systems have both military and non-military applications. For example, commercial applications include but are not limited to route navigation systems, fleet management systems, law enforcement systems, emergency services, and air traffic control systems.

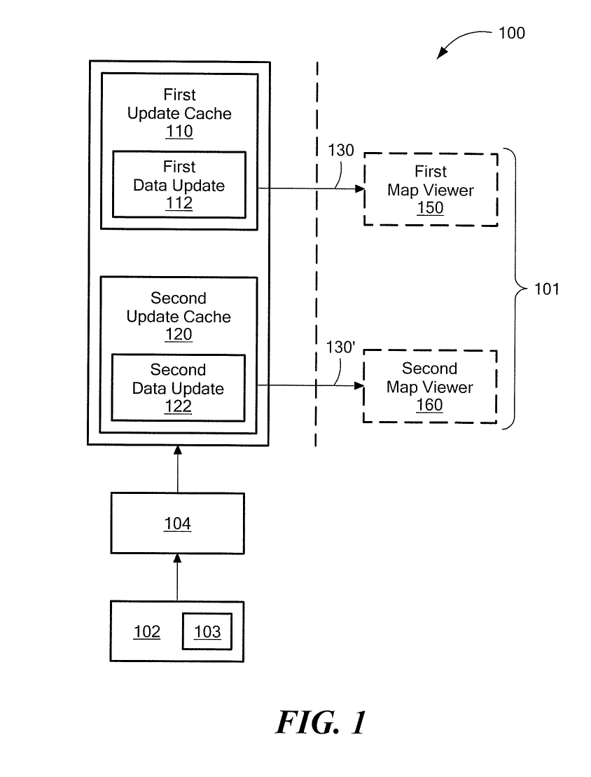

Referring now to FIG. 1, the techniques and approaches described herein include a system 100 for updating map viewers 101. The map viewers 101 are shown in phantom since they are not properly a part of the system 100. The system 100 includes a storage medium 102 having stored instructions 103 thereon that when executed by a machine 104 enable updating of caches associated with the map viewers 101. In particular, the system 100 associates a first update cache 110 with a first map viewer 150, the first update cache 110 including a first map viewer data update 112. The system 100 also associates a second update cache 120 with a second map viewer 160, the second update cache 120 including a second map viewer data update 122. The system 100 sends one or more map viewer updates 130, 130′ from one of the first and second update caches 110, 120 to the associated one of the first and second map viewers 150, 160.

In an exemplary application of the system 100, a first and second map viewer execute on a first and second client computer, respectively. In one embodiment, the map viewers enable the output and display of information to users to support military operations. Some of the information includes real-time data, such as positions of moving objects, while other information includes static information, such as locations of buildings. The first map viewer can display aircraft information in a combat zone or theater such as a first enemy aircraft violating a no-fly zone and a second friendly aircraft intercepting the enemy aircraft. The second map viewer can display defense system information such as the first enemy aircraft approaching anti-aircraft missile defense systems.

External systems can track information, such aircraft latitude, longitude, altitude, flight vectors, and speed, and can communicate the information to the system 100. For example, the external systems may automatically send or push aircraft position updates to the system 100 at regular intervals, such as every second. Alternatively, the system 100 may poll or pull the external systems to request aircraft position updates at regular intervals. The system 100 may forward the aircraft position updates to the first and second map viewers, or the map viewers may request the information from the system 100.

In the exemplary application, the system 100 uses the first update cache 110 and the second update cache 120 to store data updates. The data updates may be for moving objects, such as aircraft, troops in the field, missiles, etc. and for display configurations, such as alerts and status information. For example, the first update cache 110 may include a first data update 112 such as one or more aircraft position updates, and the second update cache 120 may include a second data update 122, which may also include one or more aircraft position updates. It will be understood, however, that the system 100 may include other types of data updates, such as troop counts, munitions, etc. The system 100 sends the first and second data updates 112, 122 to the respective first and second map viewers 150, 160.

The first and second map viewers may have different data update needs. For example, the first map viewer may require position updates for enemy and friendly aircraft, while the second map viewer may require only enemy aircraft position updates. The system 100 stores data updates for the first and second map viewers in respective first and second update caches based on the different data update needs. For example, the system 100 stores enemy and friendly aircraft position updates in the first update cache 110, but only enemy aircraft position updates in the second update cache 120.

In another embodiment, the first and second map viewers may track information at different update intervals based upon the type of information displayed. For example, fast-moving aircraft and projectiles in the first map viewer may be updated more frequently than troops, tanks, and battleships in the second map viewer. In such a case, the system 100 may send updates to the map viewers at different update intervals. Alternatively, the map viewers may request updates from the system 100 at different update intervals.

As described above, the first and second update caches are associated with the respective first and second map viewers. Various methods may be used to associate update caches to map viewers, such as links specifying update cache locations. In an embodiment of the system 100, the link is a uniform resource locator (URL) of the type well known in the art. For example, the URL may refer to a file on a server. The URL may include parameters for database queries, data feed information, and server executables.

It should be appreciated that although only two map viewers are shown in FIG. 1, more than two map viewers can be updated. In such a case, an update cache is provided for each map viewer.

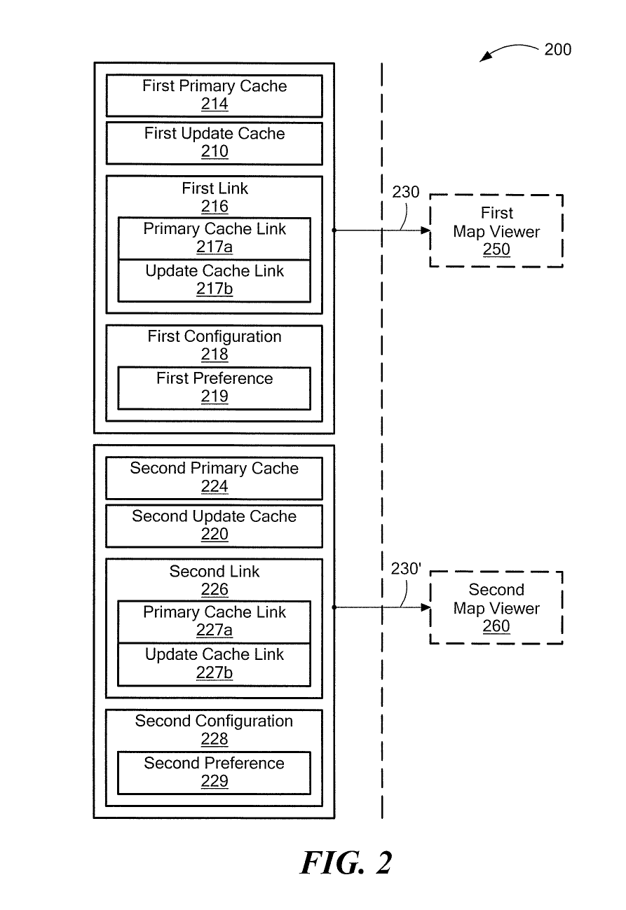

Referring now to FIG. 2, in a further embodiment of the techniques and approaches described herein, a system 200 associates a first primary cache 214 with a first map viewer 250, and associates a second primary cache 224 with a second map viewer 260. The system 200 sends rendering information 230, 230′ from one of the first and second primary caches 214, 224 to the associated one of the first and second map viewers 250, 260. Rendering information 230, 230′ includes information customized for respective map viewers 250, 260. For example, rendering information 230 may include all of the map objects displayed in the first map viewer 250, such as enemy and friendly aircraft, placemarks, geographic information, etc. Rendering information 230, 230′ may be sent when initializing the map display in the respective map viewers 250, 260. For example, a client computer may initialize a map viewer and request rendering information for at least a portion of the map objects in the map display.

In one embodiment, the rendering information is formatted using Keyhole Markup Language (KML) and sent as a KML file. The rendering information may be requested based on map viewer events, such as a reset of the map viewer to a default origin and view area, and may include a sub-portion of map objects, such as map objects viewable and activated at a current zoom level and/or within a current map viewing area. Further, the map objects may be organized on map layers for different types of content, such as roads, installations, terrain details, etc. The rendering information may include only map objects on activated or visible map layers.

Referring again to FIG. 2, in a further embodiment, the system 200 further associates a first link 216 with the first map viewer 250, and a second link 226 with a second map viewer 260. The links are used to associate caches with map viewers. The links may be created manually, for example by users accessing command and control stations. In another embodiment, the links are created automatically by generating unique identifiers for caches and map viewers. In some instances, the unique identifiers may be randomly generated and may include descriptive information which can be based upon the type of application. In the exemplary embodiment of FIG. 2, the first link 216 includes a primary cache link 217a indicating a location of the first map viewer primary cache 214, and an update cache link 217b indicating a location of the first map viewer update cache 210. Similarly, the second link 226 includes a primary cache link 227a indicating a location of the second map viewer primary cache 224, and an update cache link 227b indicating a location of the second map viewer update cache 220.

In one embodiment, the link is a URL as described above for the primary cache and/or the update cache. In another embodiment, the link may include a pair of unique references to a cache object and to a map viewer. For example, the reference may include identification entities, such as numbers and/or text strings, to identify a primary cache or update cache object, depending upon the type of link, and a map viewer. For example, the link may include a primary cache link number, such as 001, and a map viewer text string, such as “AIRCRAFT COMBAT 001”. The combination refers to a specific cache entry for a specific map viewer.

Referring again to FIG. 2, in a further embodiment, the system 200 further associates a first configuration 218 with the first map viewer 250, and a second configuration 228 with a second map viewer 260. The first configuration 218 includes at least one first preference 219, and the second configuration 228 includes at least one second preference 229. First and second preferences 219, 229 may include preferred styles to define, for example, colors, fonts, and icons used to render map objects.

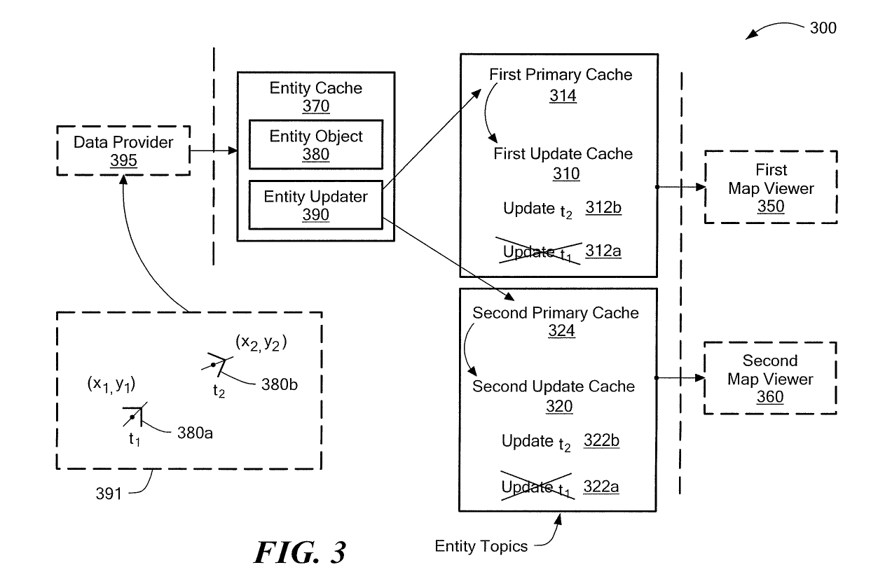

Referring now to FIG. 3, in a further embodiment of the techniques and systems described herein, a system 300 includes an entity cache 370 associated with a first primary cache 314 and a second primary cache 324. The entity cache 370 includes at least one entity object 380. The entity object 380 refers to a map object (not shown) displayed in a map viewer 350, 360. For example, the entity object 380 may include data fields necessary to render the entity object 380 including, but not limited to, the shape of the entity object 380. Shapes include two-dimensional shapes, such as points, lines, arcs, circles, and polygons, block, and three-dimensional shapes, such as blocks, spheres, volumes, and trajectories. Further, the data fields may include style information to define colors, patterns, and fonts used to render the entity object 380.

As an example, the entity object 380 may be a placemark used to annotate a map. The placemark can be a two-dimensional point having a latitude, longitude, and altitude to indicate geographic location, a symbol, such as a push-pin graphic, and a color, such as red, green, or yellow, to indicate a status of the placemark. In another example, the entity object 380 may be a radar object having a detection range and an affiliation field. The radar object may be drawn as a two-dimensional colored shape and may include a name rendered as a text string on the map. The text string may be further defined by styles, such as a font and font-size.

Referring again to FIG. 3, a further embodiment of the entity cache 370 includes an entity updater 390 associated with the entity object 380. The entity updater 390 processes at least one update to the entity object 380. An exemplary entity object of an aircraft 380a, 380b displayed on a map 391 is shown at a first position (X₁, Y₁) at a first time t₁ and at a second position (X₂, Y₂) at a second time t₂. Here, X and Y coordinates refer to latitude and longitude, respectively. A data provider 395 may communicate the aircraft's position to the system 300. For example, the data provider 395 may be a data source that receives aircraft positioning information from an air traffic control system. At time t₁, the data provider sends (or the system 300 requests) the position of the aircraft 380a at (X₁, Y₁). The entity updater 390 associated with the aircraft entity object 380 is notified of an update to the aircraft entity object 380, for example, via an event queue that stores update notifications and forwards them to the proper entity updater for an entity object. The entity updater 390 propagates the update to the map viewers, for example, via a first and second primary cache 314, 324. The first and second primary caches 314, 324 further propagate the update to a first and second update cache 310, 320. The update at t₁ is stored in the first update cache 310 as a first update 312a and in the second update cache 320 as a second update 322a. The first and second updates 312a, 322a are sent to the respective first and second map viewers 350, 360. It should be noted that data provider 395, map 391, and map viewers 350, 360 are shown in phantom since they are not properly a part of the system 300.

In a further embodiment, at least two updates to the aircraft's position may be collapsed and sent to the map viewers as a single update. Such techniques can save overhead, especially when updates between the system and the map viewers are asynchronous. For example, data providers may send data updates over a dedicated connection every 0.1 milliseconds, while the map viewers may request (or the system may send) data updates every second over a shared network. In some instances, a series of updates may be sent to the system and collapsed into a single update, and the system sends the single update to the map viewers.

Referring again to FIG. 3, the data provider 395 may send a second aircraft position update (X₂, Y₂) at time t₂ to the system 300. The second aircraft position update (X₂, Y₂) is propagated to the first and second update caches 310, 320 and stored as respective third and forth updates 312b, 322b. In this instance, the first and second updates 312a, 322a are replaced with respective third and fourth updates 312b, 322b. In another embodiment, the first and second updates 312a, 322a are replaced by not removed from the update caches so that the first and second updates 312a, 322a can be recalled, for example, to retrace or reverse the aircraft's position.

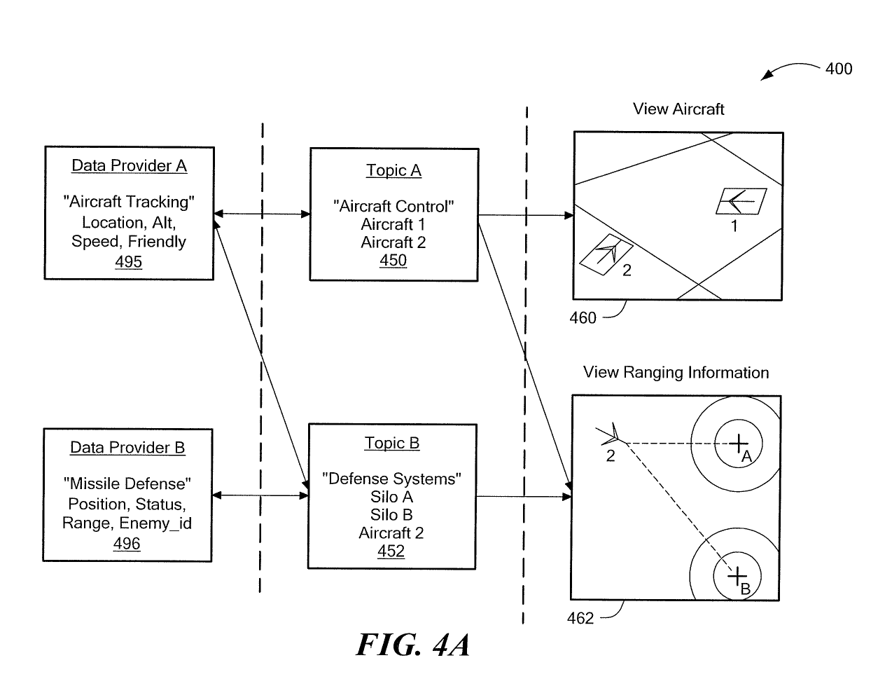

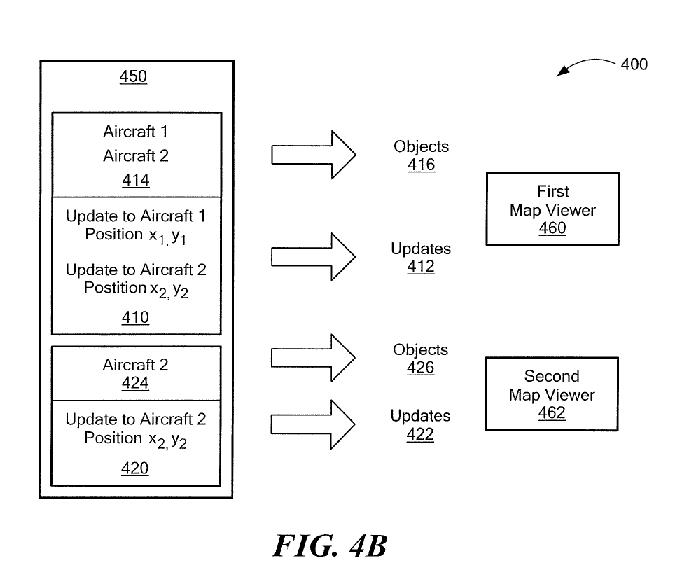

Referring now to FIG. 4A, an environment incorporating a system 400 for updating map viewers will now be described in further detail and with reference to topics, which are applications supporting various types of data viewed by map viewers. As shown in FIG. 4A, the system 400 includes a first topic 450, which may be referred to as Topic A called “AIRCRAFT CONTROL” and a second topic 452, which may be referred to as Topic B called “DEFENSE SYSTEMS”. The first topic 450 is for tracking and displaying enemy and friendly aircraft, and may include one or more aircraft entity objects representing aircraft. The first topic 450 is connected to a first data provider 495, which may be referred to as Data Provider A called “AIRCRAFT TRACKING”. The first data provider 495 receives aircraft information, for example, from an air traffic communications system, and sends aircraft information to the first topic 450. For example, the aircraft information may include location, altitude, speed, and whether or not the aircraft is friendly.

It will be understood that various techniques may be used to send the information. For example, the data providers may push the information to entity caches in the system 400, or the system 400 may pull the information from the data providers. Further, various update intervals may be supported.

The second topic 452 is for tracking and displaying missile defense information, and may include one or more missile silo entity objects representing missile silos, as well as aircraft entity objects representing targeted enemy aircraft. The second topic 452 is connected to a second data provider 496, which may be referred to as Data Provider B called “MISSILE DEFENSE”. The second data provider 496 receives ranging and missile tracking information, for example, from a radar guidance system, and sends the information to the second topic 452. For example, the tracking information may include position, status, range, and enemy identifications. The second topic 452 is also connected to the first data provider 495 to obtain enemy aircraft information.

Organizations use map viewers to support various data applications. For example, the military can use map viewers 460, 462 to support various military command and control operations. For example, a first map viewer 460 can support intercept missions and a second map viewer 462 can support missile defense control. The map viewers may be viewed on a shared display, or on separate displays.

The topics 450, 452 are associated with and send map object information to one or more of the map viewers 460, 462. For example, the first topic 450 sends aircraft information to the first map viewer 460 and the second map viewer 462, however, only enemy aircraft information is sent to the second map viewer 462 because the ranging information concerns only enemy aircraft. Further, the second topic 452 sends ranging and missile tracking information to the second map viewer 462. It will be understood that various methods may be used to send the information from the system topics to the map viewers. For example, the system 400 may push the information to the map viewers, or the map viewers may pull the information from the system 400.

Referring now to FIG. 4B, in which like elements of FIG. 4A are provided having like reference numerals, the first topic 450 includes a first primary cache 414 and a first update cache 410 associated with a first map viewer 460, and a second primary cache 424 and a second update cache 420 associated with a second map viewer 462. The first primary cache 414 includes map objects needed to support the first map viewer 460 and the second primary cache 424 includes map objects needed to support the second map viewer 462. Further, the first update cache 410 includes all updates to map objects in the first map viewer 460, and the second update cache 420 includes all updates to map objects in the second map viewer 462.

The dedicated caches allow map viewers to request and receive only pertinent map object information, as will now be described in further detail. All or a subset of the map objects can be sent from the primary caches 414, 424 to the associated map viewers 460, 462 based on the status and view areas of the map viewers. For example, to initialize the first map viewer 460, all of the data for displayed map objects 416, namely, AIRCRAFT1 and AIRCRAFT2, can be sent from the first primary cache 414 to the first map viewer 460. Likewise, to initialize the second map viewer 462, all of the data for displayed map objects 426, namely, AIRCRAFT2, can be sent from the second primary cache 424 to the second map viewer 462. Once all map objects for a particular zoom level or viewing area have been received, only updated information in the dedicated update caches needs to be sent to the map viewer. For example, to update the first map viewer 460, the updates 412 to AIRCRAFT1 and AIRCRAFT2 can be sent from the first update cache 410 to the first map viewer 460. Likewise, to update the second map viewer 462, the updates 422 to AIRCRAFT2 can be sent from the second update cache 420 to the second map viewer 462. In this way, the system 400 can minimize overhead because only updated information needs to be processed, stored, and sent after the map viewers have been initialized.

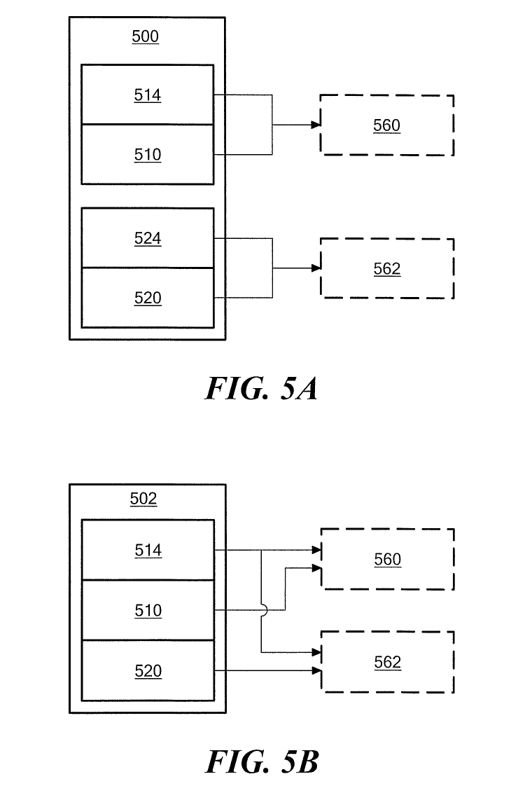

In a further embodiment of the techniques described herein, a topic is an entity topic which associates a primary cache and an update cache with a map viewer. Referring to FIG. 5A, entity topic 500 includes a first primary cache 514 and a first update cache 510 associated with a first map viewer 560. Further, the entity topic 500 includes a second primary cache 524 and a second update cache 520 associated with a second map viewer 562.

Referring now to FIG. 5B, another embodiment of a topic 502 is a Keyhole Markup Language (KML) topic which includes a primary cache 514 associated with a first map viewer 560 and a second map viewer 562, and a first update cache 510 associated with the first map viewer 560 and a second update cache 520 associated with the second map viewer 562. As can be seen from FIGS. 5A and 5B, entity topics include a dedicated primary cache for each map viewer, whereas KML topics include a primary cache shared by all map viewers. Both entity and KML topics, however, include dedicated update caches for each map viewer.

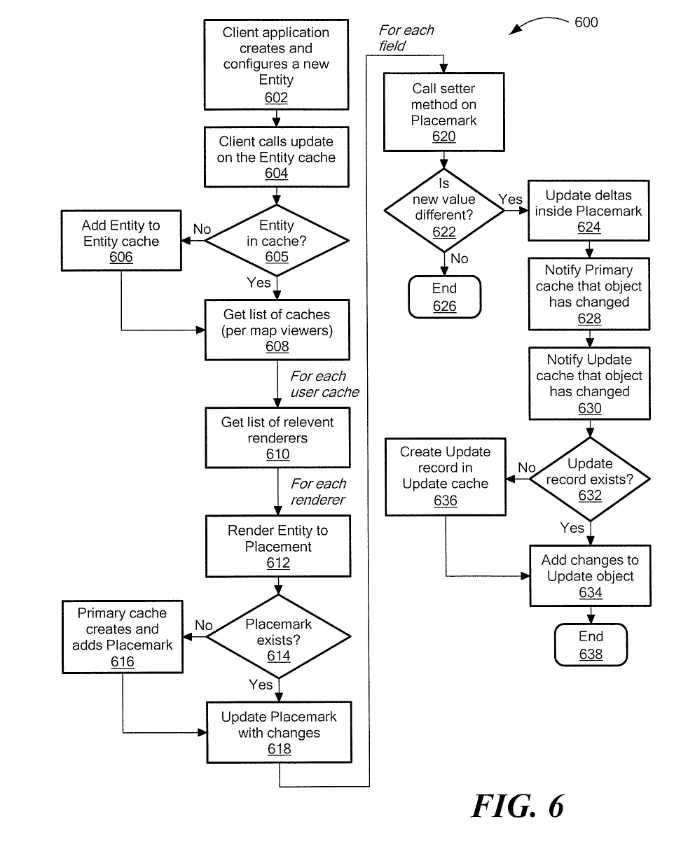

Creating and updating a map object in an entity topic and a KML topic will now be described. Referring to FIG. 6, an embodiment of a method 600 for creating and updating a map object in an entity topic includes an application creating and configuring 602 a new entity object. The application calls 604 an update function on an entity cache on a system. If the entity object is not in the entity cache 605, the entity object is added 606 to the entity cache. Otherwise, a list of all caches 608 and all renderers 610 is obtained, and the entity object is rendered 612. For example, each map viewer is associated with a cache, and each cache may include a different renderer for rendering the entity object. As an example, the entity object may be a placemark, which is rendered differently in one or more of the map viewers. For example, the placemark may be rendered using a push-pin icon and a point in one map viewer, and using a three-dimensional dome object in another map viewer. Once the placemark is rendered, the method 600 includes determining whether the placemark exists in the primary caches 614. If not, the primary cache creates the placemark 616. Any updates to the placemark are generated 618, for example, if a placemark position or status has changed. A setter function is called 620 on placemark fields. If a current field value is different than an updated field value 622, update deltas are created 624. For example, an update delta may be a change in position. If the current field value and updated field value are the same, the method 600 may terminate 626.

The primary cache is notified 628 of a change to an entity object and the primary cache notifies 630 the update cache to create or add an update record. If an update record already exists in the update cache 632, the update is added in the update cache 634; otherwise, an update record is created in the update cache 636 before it is added to the update cache. The method 600 may then terminate 638.

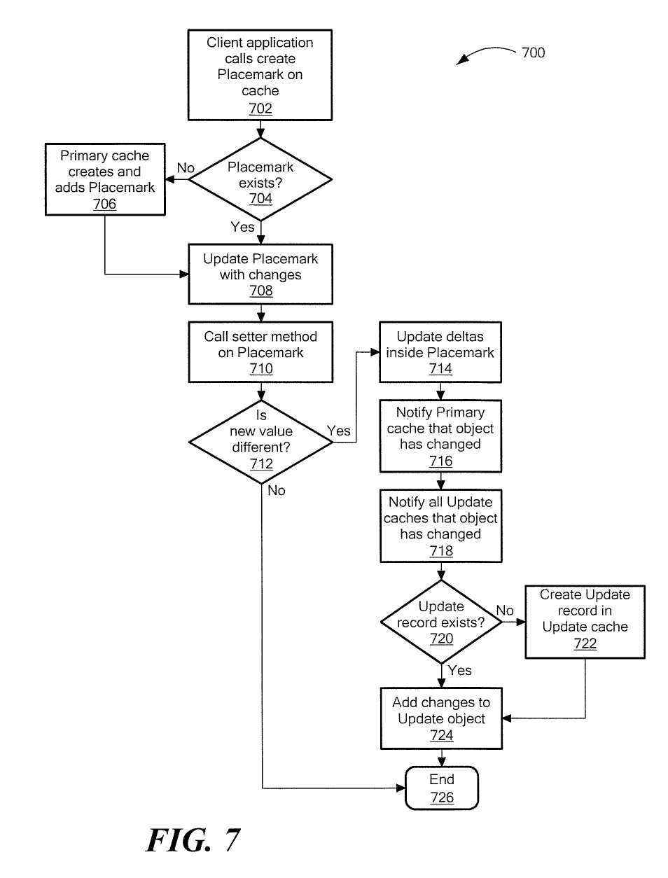

Referring now to FIG. 7, an embodiment of a method 700 for creating and updating a map object in a KML topic includes creating 702 a new object, for example, a placemark object in a cache. If the placemark object does not exist in the primary cache 704, the primary cache creates 706 the placemark object. The placemark object is updated 708 and a setter function is called 710 on the placemark object. If current values are different than updated values 712, update deltas are created 714; otherwise, the method 700 may terminate 726. The primary cache is notified 716 of a change to an object and the primary cache notifies 718 all of the update caches. If an update record does not exist in the update cache 720, an update record is created 722 in the update cache. Next, the changes to the update caches are added 724 and the method 700 may terminate 726.

As can be understood from the above descriptions, a one-to-one relationship exists between primary caches and update caches for map viewers when creating and updating entity objects. In contrast, a one-to-many relationship exists between a primary cache and update caches for the map viewers when creating and updating KML objects.

In one embodiment of the techniques described herein, an entity object is an extension of a base map object to facilitate creating custom map objects and map object renderers. The base map objects may be defined in an existing map format, such as KML. In a further embodiment, entity objects and KML objects are rendered in KML format and sent to map viewers. The entity objects may need to be converted into KML before being sent to map viewers. The map viewers can interpret the KML format and render the objects.

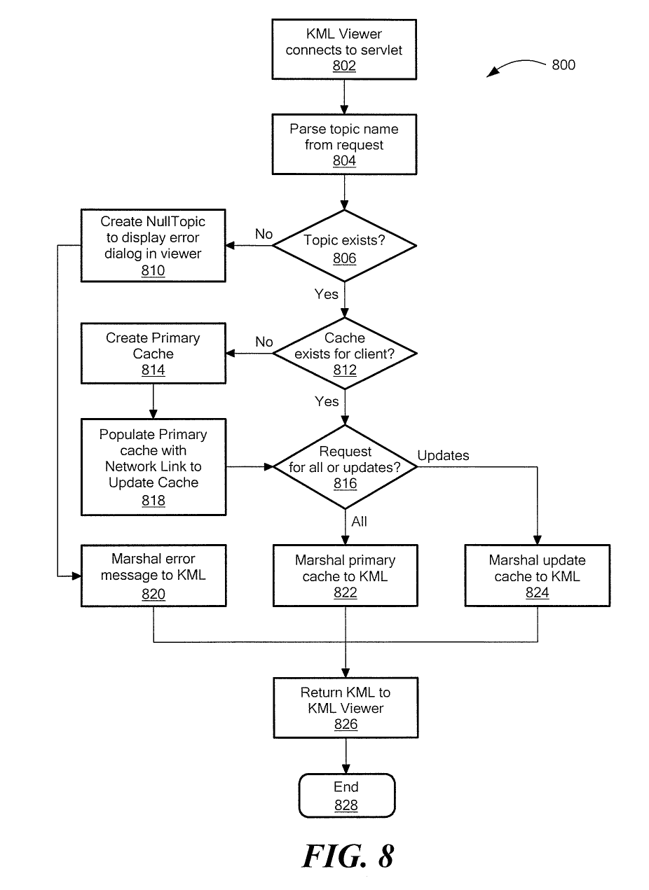

Referring now to FIG. 8, in an embodiment of the techniques described herein includes a method 800 for handling requests from a KML map viewer. The method 800 includes a KML viewer connecting to a server 802. The server may execute a Java servlet to handle requests from the KML viewer. The request includes a topic name for a topic of the type described above. The topic name is parsed 804 from the request and if no topic is found with the topic name 806, an error message is generated 810, which may be marshaled 820 and sent back to the KML viewer 826. Otherwise, if a primary cache does not exist for the topic 812, a primary cache is created 814 and populated with a link to the primary cache 818. Further, an update cache is created for the KML viewer along with a link to the update cache. The request is further parsed to determine if all objects are requested or only updates are requested 816. If all objects are requested, the objects are marshaled 822 to KML and sent to the KML viewer 826. If updates are requested, the updates are marshaled 824 to KML and sent to the KML viewer 826 and the method 800 may terminate 828.

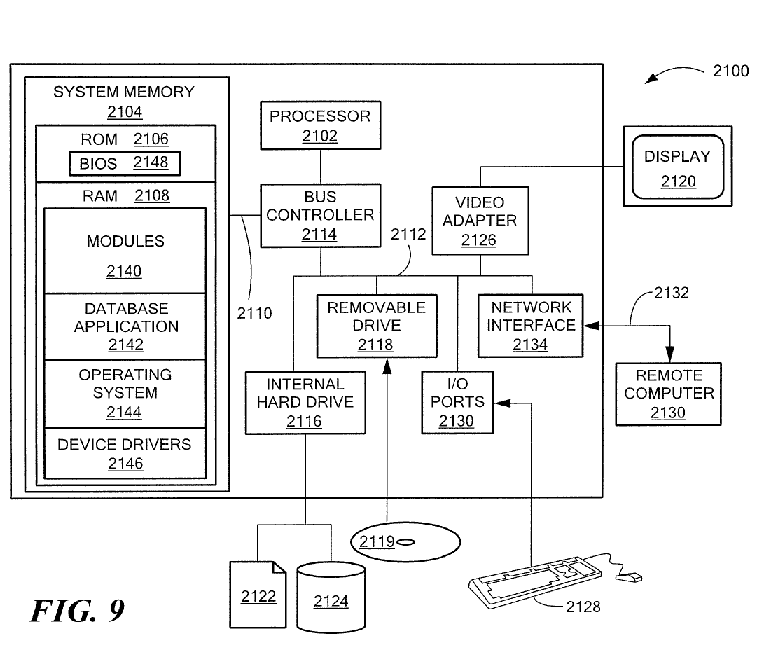

FIG. 9 illustrates a computer 2100 suitable for supporting the operation of an embodiment of the techniques and systems described herein. The computer 2100 includes a processor 2102, for example, a dual-core processor, such as the AMD Athlon™ X2 Dual Core processor from the Advanced Micro Devices Corporation. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents and device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2130. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing map object transfers and updates from the computer 2100 to map viewers. In particular, map objects representing real-world objects may be initialized and sent from the computer 2100 to enable output to map viewers. Updates to map objects are also sent from the computer 2100 to enable output to map viewers. The computer 2100 may receive updates to real-world objects from external sources tracking the real-world objects. The updates are processed and saved as map object updates in update caches on the computer 2100, and sent from the update caches to the map viewers.

In a further embodiment, the computer 2100 may process updates for a first map viewer using a first processor and a first update cache associated with the first map viewer. Further, the computer 2100 may process updates for a second map viewer using a second processor and a second update cache associated with the second map viewer. For example, the first and second processor may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 and/or passed over the network 2132 to the remote computer 2130 and other systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2130, video adapter 2126, and printers.

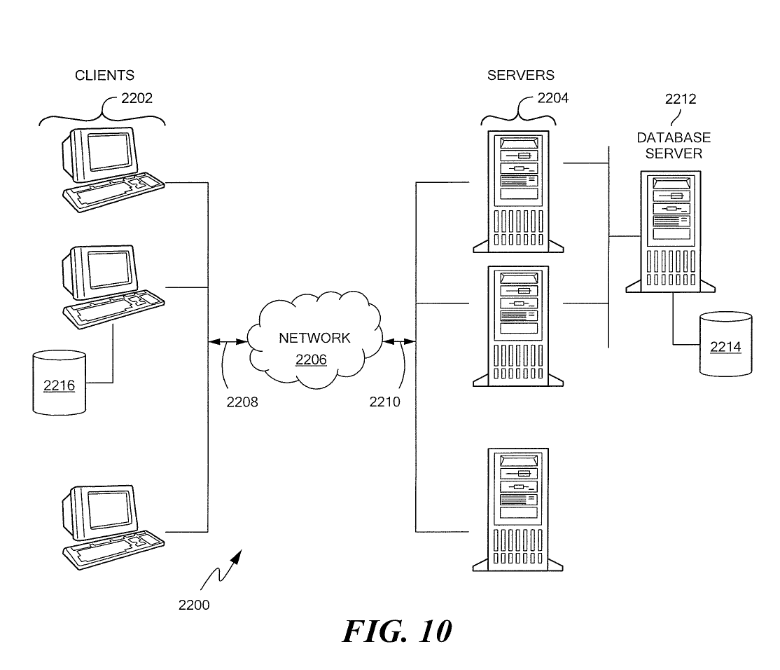

FIG. 10 illustrates a client-server environment 2200 for supporting the operation of an embodiment of the inventive systems, concepts, and techniques described herein. Client computers 2202 are coupled to server computers 2204 via a network 2206, such as an intranet or the Internet. Client computer users may access applications and resources executing on the server computers 2204 by issuing requests 2208 over network 2206. The requests 2208 may include command-line options and data values to delineate the requests. Server computers 2204 accept and process requests 2208 and may access structured data stored in databases 2214 on database servers 2212. Server computers 2204 return information 2210 to the client computers 2202 via network 2206. In response, client computers 2202 provide information in an appropriate format to client users, for example, using a web client or other client computer-readable modules. In one embodiment, the client computer 2202 may execute a local application for supporting the operation the inventive systems, concepts, and techniques described herein, which may include accessing a local copy of data in a local database 2216.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An article for updating map viewers, comprising:
a storage medium having stored instructions thereon that when executed by a machine result in:
associating a first map viewer update cache with a first map viewer, the first map viewer update cache comprising a first map viewer data update;
associating a second map viewer update cache with a second map viewer, the second map viewer update cache comprising a second map viewer data update; and
sending one of the first and second map viewer data updates from one of the first and second map viewer update caches to the associated one of the first and second map viewers.

2. The article according to claim 1, further comprising:
associating a first map viewer primary cache with the first map viewer, the first map viewer primary cache comprising rendering information for the first map viewer;
associating a second map viewer primary cache with the second map viewer, the second map viewer primary cache comprising rendering information for the second map viewer; and
sending the rendering information from the one of the first and second map viewer primary caches to the associated one of the first and second map viewers.

3. The article according to claim 2, further comprising:
associating a first map viewer link with the first map viewer, the first map viewer link comprising:
a primary cache link indicating a location of the first map viewer primary cache; and
an update cache link indicating a location of the first map viewer update cache;
associating a second map viewer link with the second map viewer, the second map viewer link comprising:
a primary cache link indicating a location of the second map viewer primary cache; and
an update cache link indicating a location of the second map viewer update cache;
wherein sending one of the first and second map viewer data updates further comprises using the update cache link of one of the first and second map viewer links to locate the at least one map viewer update, and sending the rendering information further comprises using the primary cache link of the one of the first and second map viewer links to locate the rendering information.

4. The article according to claim 2, further comprising:
associating an entity cache with the first and second primary caches, the entity cache comprising:
at least one entity object.

5. The article according to claim 4, wherein the entity cache further comprises:
at least one entity updater associated with the at least one entity object, the at least one entity updater to process at least one update to the at least one entity object.

6. The article according to claim 5, further comprising:
propagating the at least one update to one of the first and second map viewer update caches.

7. The article according to claim 6, wherein propagating comprises:
from the entity updater, propagating the at least one update to at least one of the first and second primary caches; and
from the at least one of the first and second primary caches, propagating the at least one update to at least one of the first and second update caches.

8. The article according to claim 6, wherein the at least one entity update is a plurality of entity updates collapsed into a single entity update.

9. The article according to claim 2, further comprising:
associating a first map viewer configuration with the first map viewer, the first map viewer configuration comprising at least one first map viewer preference; and
associating a second map viewer configuration with the second map viewer, the second map viewer configuration comprising at least one second map viewer preference;
wherein sending the one of the first and second map viewer data updates is based on one of the first and second map viewer configurations of the associated one of the first and second map viewers.

10. The article according to claim 1, further comprising:
associating a map viewer primary cache with the first map viewer and the second map viewer, the first map viewer primary cache comprising rendering information for the first and second map viewer; and
sending the rendering information from the map viewer primary caches to one of the first and second map viewers.

11. The article according to claim 10, further comprising:
associating an entity cache with the map viewer primary cache, the entity cache comprising:
at least one entity object.

12. The article according to claim 10, wherein the entity cache further comprises:
at least one entity updater associated with the at least one entity object, the at least one entity updater to process at least one update to the at least one entity object.

13. The article according to claim 12, further comprising:
from the at least one entity updater, propagating the at least one update to the map viewer primary caches; and
from the map viewer primary cache, propagating the at least one update to at least one of the first and second update caches.

14. The article according to claim 1, wherein the first and second map viewer data updates are converted to a map viewing format.

15. The article according to claim 14, wherein the map viewing format is keyhole markup language.

16. The article according to claim 15, wherein the first and second map viewers use keyhole markup language to represent map information.

17. A method for updating map viewers, comprising:
associating a first map viewer update cache with a first map viewer, the first map viewer update cache comprising a first map viewer data update;
associating a second map viewer update cache with a second map viewer, the second map viewer update cache comprising a second map viewer data update; and
sending one of the first and second map viewer data updates from one of the first and second map viewer update caches to the associated one of the first and second map viewers.

18. The method according to claim 17, further comprising:
associating a first map viewer primary cache with the first map viewer, the first map viewer primary cache comprising rendering information for the first map viewer;
associating a second map viewer primary cache with the second map viewer, the second map viewer primary cache comprising rendering information for the second map viewer; and
sending the rendering information from the one of the first and second map viewer primary caches to the associated one of the first and second map viewers.

19. The method according to claim 18, further comprising:
associating a first map viewer link with the first map viewer, the first map viewer link comprising:
a primary cache link indicating a location of the first map viewer primary cache; and
an update cache link indicating a location of the first map viewer update cache;
associating a second map viewer link with the second map viewer, the second map viewer link comprising:
a primary cache link indicating a location of the second map viewer primary cache; and
an update cache link indicating a location of the second map viewer update cache;
wherein sending one of the first and second map viewer data updates further comprises using the update cache link of one of the first and second map viewer links to locate the at least one map viewer update, and sending the rendering information further comprises using the primary cache link of the one of the first and second map viewer links to locate the rendering information.

20. The method according to claim 18, further comprising:
associating a first map viewer configuration with the first map viewer, the first map viewer configuration comprising at least one first map viewer preference; and
associating a second map viewer configuration with the second map viewer, the second map viewer configuration comprising at least one second map viewer preference;
wherein sending the one of the first and second map viewer data updates is based on one of the first and second map viewer configurations of the associated one of the first and second map viewers.

21. The method according to claim 17, further comprising:
associating a map viewer primary cache with the first map viewer and the second map viewer, the first map viewer primary cache comprising rendering information for the first and second map viewer; and
sending the rendering information from the map viewer primary caches to one of the first and second map viewers.

22. A system, comprising:
a processor; and
a memory coupled to the processor, the memory including program instructions for updating map viewers by:
associating a first map viewer update cache with a first map viewer, the first map viewer update cache comprising a first map viewer data update;
associating a second map viewer update cache with a second map viewer, the second map viewer update cache comprising a second map viewer data update; and
sending one of the first and second map viewer data updates from one of the first and second map viewer update caches to the associated one of the first and second map viewers.

23. The system according to claim 22, further including:
associating a first map viewer primary cache with the first map viewer, the first map viewer primary cache comprising rendering information for the first map viewer;
associating a second map viewer primary cache with the second map viewer, the second map viewer primary cache comprising rendering information for the second map viewer; and
sending the rendering information from the one of the first and second map viewer primary caches to the associated one of the first and second map viewers.

24. The system according to claim 23, further including:
associating a first map viewer link with the first map viewer, the first map viewer link comprising:
a primary cache link indicating a location of the first map viewer primary cache; and
an update cache link indicating a location of the first map viewer update cache;
associating a second map viewer link with the second map viewer, the second map viewer link comprising:
a primary cache link indicating a location of the second map viewer primary cache; and
an update cache link indicating a location of the second map viewer update cache;
wherein sending one of the first and second map viewer data updates further comprises using the update cache link of one of the first and second map viewer links to locate the at least one map viewer update, and sending the rendering information further comprises using the primary cache link of the one of the first and second map viewer links to locate the rendering information.

25. The system according to claim 23, further including:
associating a first map viewer configuration with the first map viewer, the first map viewer configuration comprising at least one first map viewer preference; and
associating a second map viewer configuration with the second map viewer, the second map viewer configuration comprising at least one second map viewer preference;
wherein sending the one of the first and second map viewer data updates is based on one of the first and second map viewer configurations of the associated one of the first and second map viewers.

26. The system according to claim 22, further including:
associating a map viewer primary cache with the first map viewer and the second map viewer, the first map viewer primary cache comprising rendering information for the first and second map viewer; and
sending the rendering information from the map viewer primary caches to one of the first and second map viewers.
